(19) United States
(12) Patent Application Publication
(10) Pub. No.: US 2008/0275941 A1
(43) Pub. Date: Nov. 6, 2008

(54) Service Integration on a Network

(75) Inventors: Nagesh S. Shekar, Jayanagar (IN); Vikram Saksena, Acton, MA (US); Fardad Farahmand, Wellesley, MA (US); Sunil Menon, Ramagondahalli Bangalore (IN); Nagesh Kumar Bollapalli Venkata, Bangalore (IN); Arjun Cholkar, Vibhutipura (IN); Ashish Nagpal, Kundalahalli (IN)

Correspondence Address: PROSKAUER ROSE LLP, ONE INTERNATIONAL PLACE, BOSTON, MA, 02110, US

(73) Assignee: Sonus Networks, Inc., Westford, MA (US)

(21) Appl. No.: 11/743,966

(22) Filed: May 3, 2007

(51) Int. Cl. G06F 15/16; H04L 12/66

(52) U.S. Cl. 709/203; 370/352; 370/408; 455/414.1

(57) ABSTRACT

Described are computer-based methods and apparatuses, including computer program products, for service integration on a network. Telecommunication services (e.g., calendar, television, phone, location) on a network are integrated using service codelets designed to interface with the services. A default codelet associated with the user (e.g., via a service plan) dynamically calls the service codelets to request information from the associated services (e.g., calendar data) and/or perform tasks with the associated services (e.g., update calendar). The service codelets can dynamically call other service codelets based on the results of their requests for information. The information from the services is integrated and returned to the user.

### CROSS REFERENCES TO RELATED APPLICATIONS

This application relates to and is assigned to the same entity as the co-pending application identified by Attorney Docket No. SNS-023, entitled “Personal Service Integration on a Network,” U.S. Patent Application No. TBD, filed on May 3, 2007, the disclosure of which is hereby incorporated herein by reference.

### FIELD OF THE INVENTION

The present invention relates generally to computer-based methods and apparatuses, including computer program products, for telecommunication service integration on a network.

### BACKGROUND

Telecommunications networks are increasing in size and complexity. The increase in size and complexity of telecommunication networks is due in part to the increase in the number of telecommunication services and the increase in the number of users on telecommunication networks. New telecommunication services are added to telecommunication networks on a regular basis which adds to the size and complexity of the telecommunication network.

The telecommunication services communicate utilizing session initiation protocol (SIP) and internet protocol multimedia system (IMS). The communication of telecommunication services utilizing SIP and IMS and the number of telecommunications services needed to service the large number of users increases the complexity of the telecommunication network by dramatically increasing the communication messages on the network so that the different services can communicate with each other. The increased number of telecommunication services and the increased number of users causes a dramatic increase in the size and the complexity of the network. This increase in the network causes access to the network to become challenging if not impossible when new services are added and during peak periods of use by users.

### SUMMARY OF THE INVENTION

One approach to service integration on a network is a method. The method includes receiving a request from a user, associating a default codelet with the request, processing the default codelet to associate a plurality of service codelets with the request, processing a first codelet from the plurality of service codelets to communicate with a first resource server, and processing a second codelet from the plurality of service codelets to communicate with a second resource server. The first codelet is different from the second codelet and the first resource server is different from the second resource server.

Another approach to service integration on a network is a computer program. The computer program product is tangibly embodied in an information carrier. The computer program product includes instructions being operable to cause a data processing apparatus to receive a request from a user, associate a default codelet with the request, process the default codelet to associate a plurality of service codelets with the request, process a first codelet from the plurality of service codelets to communicate with a first resource server, process a second codelet from the plurality of service codelets to communicate with a second resource server. The first codelet is different from the second codelet and the first resource server is different from the second resource server.

Another approach to service integration on a network is a system. The system includes a service handler module, a default codelet, a first codelet, and a second codelet. The service handler module is configured to receive a request from a computing device. The default codelet is configured to associate a plurality of service codelets with the request. The first codelet from the plurality of service codelets is configured to communicate with a first resource server. The second codelet from the plurality of service codelets is configured to communicate with a second resource server. The first codelet is different from the second codelet. The first resource server is different from the second resource server.

Another approach to service integration on a network is a system. The system includes a means for receiving a request from a computing device, a means for associating a plurality of service codelets with the request, a means for communicating with a first resource server, and a means for communication with a second resource server. The means for communicating with the first resource server is different from the means for communicating with the second resource server. The first resource server is different from the second resource server.

In other examples, any of the approaches above can include one or more of the following features. The second codelet utilizes results from the processing of the first codelet. The processing the default codelet further includes selecting a third codelet based on a default template, information associated with the user, and/or policy information associated with a business application.

In some examples, a third codelet is processed from the plurality of service codelets to communicate with a third resource server. The third codelet is selected based on processing the first codelet.

In other examples, a fourth codelet is processed from the plurality of service codelets to communicate with a fourth resource server. The fourth codelet is selected based on processing the first codelet.

In some examples, a blended service package includes the default codelet, the first codelet, the second codelet, the third codelet, the fourth codelet, and/or a extensible markup language descriptor file.

In other examples, the fourth codelet is prioritized for processing before the third codelet. The default codelet is processed to generate a list of codelets. A predetermined grouping including the first codelet and the second codelet is defined. The first codelet and the second codelet are deployed at runtime.

In some examples, the first resource server is associated with one or more application servers. The one or more application servers include a presence server, a calendar server, a messaging server, a conference server, a collaboration server, a location server, a personalization server, an electronic mail server, a business communication server, a phone server, a voicemail server, an internet television server, and/or a storage server.

In other examples, the first resource server is associated with message conversion, presence status capabilities, calendar capabilities, message transmission and receiving capabilities, conference capabilities, location identification capabilities, social attribute identification capabilities, business communication capabilities, electronic mail capabilities, phone capabilities, voicemail capabilities, television capabilities, and/or storage capabilities.

In some examples, the first resource server is associated with one or more IPTV capabilities. The one or more IPTV capabilities includes advertisement insertion, extracting user preferences from a content search application, and/or content searching.

In other examples, the first resource server is associated with a personal service server. The plurality of service codelets includes reentrant software. The plurality of service codelets includes multi-threaded software.

In some examples, a third codelet from the plurality of service codelets is configured to communicate with a third resource server and the third codelet is selected by the first codelet.

In other examples, a fourth codelet from the plurality of service codelets is configured to communicate with a fourth resource server and the fourth codelet is selected by the first codelet.

In some examples, a voice to text module is configured to convert the request from an audio format to a non-audio format.

Any of the aspects and examples above can provide one or more of the following advantages. An advantage to the integration of services on a network is that services can be integrated together to allow for services to have information regarding presence, location, policies, and/or user preferences. Another advantage is that existing services that do not have information associated with other services can be expanded to include information associated with the other services. For example, a calendar service that does not have access to location information can be integrated so that location information associated with a location service is integrated into the information from the calendar service.

An additional advantage to the integration of services on a network is that an existing service can be added into an integration of services without modifying the existing services by utilizing the ability to request information from the existing services and/or perform tasks with the existing services. Another advantage is that the ability to add, delete, and/or modify the services that are available for integration on a network allows for services to be quickly and efficiently integrated into other services on a network.

Another advantage to the integration of services on a network is that the service codelets communicating with the services can be prioritized so that multiple services can proceed based on a network event. An additional advantage is that the service codelets communicating with the services can be linked together so that multiple services can be called in a predetermined sequence. Another advantage is that new combinations of services can be added to allow for the synergistic integration of services on the network.

An additional advantage to the integration of services on a network is that different networks can utilize the same services which allows for a cross-platform use of services. For example, a first user on a wireless network can utilize the same calendar and conference services as a second user on a wired network. Another advantage is that a user can utilize the integrated services without having to be aware of the interfaces to the specific services because service codelets are used to access the services.

Another advantage to the integration of services on a network is that blended service packages can be utilized to combine services to allow for the synergistic integration of services on the network. For example, a blended service package can be formed between a calendar service and conference service to enable a user to access not only the information associated with the calendar service and the conference service but also the information that results from the combination of the information from the calendar service and the conference service. An additional advantage is that blended service packages can be utilized to modularize access to different sets of services. For example, a user can be associated with a meeting service package that accesses a calendar service and a conference service and a conference call package that accesses a location service and a phone service allowing for different service packages to be called based on the type of service integration that the user needs to utilize.

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 is a functional block diagram of an exemplary system illustrating service integration on a network.

FIG. 2 is a functional block diagram of an exemplary system illustrating a blended service package providing service integration on a network.

FIG. 3A is a diagram of exemplary calendar information.

FIG. 3B is a diagram of exemplary conference information.

FIG. 4 is a exemplary screenshot of information illustrating an interaction between a user and a service broker server.

FIG. 5 is an exemplary diagram illustrating an interaction between a user and a cell phone to place a request.

FIG. 6A is a diagram of exemplary calendar information.

FIG. 6B is a diagram of exemplary presence information.

FIG. 7 is an exemplary process diagram illustrating an interaction between a user and a service network to place a request.

FIG. 8 is an exemplary flowchart depicting processing of a default codelet and service codelets.

FIG. 9 is an exemplary flowchart depicting processing of a default codelet and service codelets.

### DETAILED DESCRIPTION

In general overview, services (e.g., calendar, television, phone, location) on a network are integrated using service codelets designed to interface with the services. A default codelet associated with the user (e.g., via a service plan) dynamically calls the service codelets to request information from the associated services (e.g., calendar data) and/or perform tasks with the associated services (e.g., update calendar). The service codelets can dynamically call other service codelets based on the results of their requests for information. The information from the services is integrated and returned to the user.

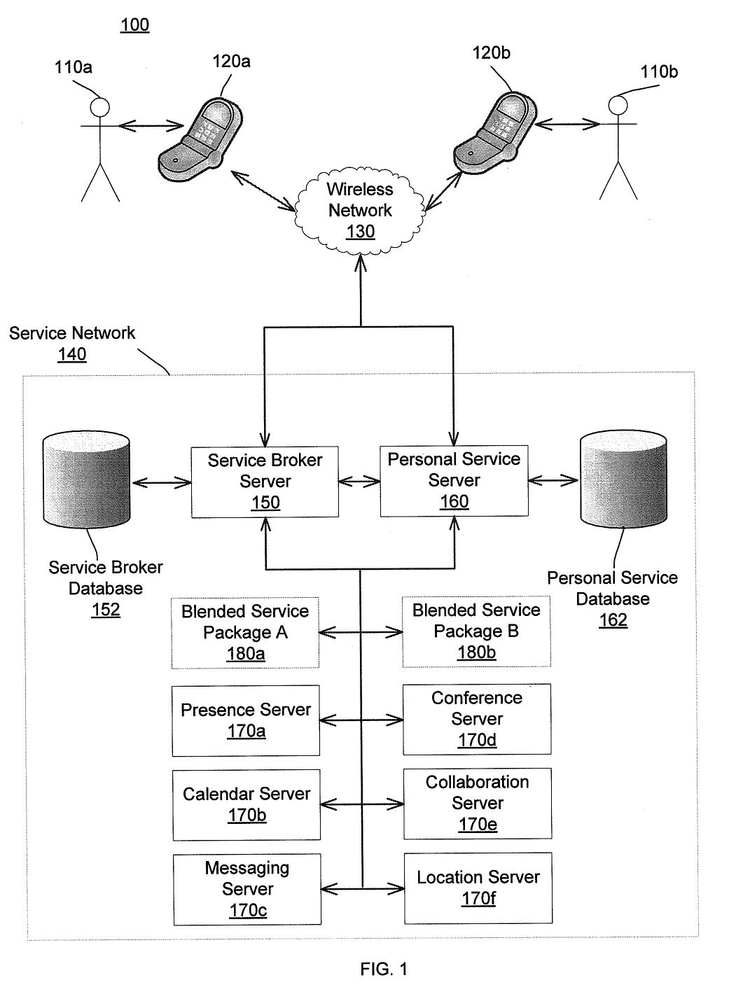

FIG. 1 is a functional block diagram of an exemplary system 100 illustrating service integration on a network. A user 110a or 110b (generally 110) utilizing a computing device 120a or 120b (generally 120) accesses a service network 140 through a network 130. The service network 140 includes a service broker server 150, a personal service server 160, a service broker database 152, a personal service database 162, blended service package A 180a, blended service package B 180b, and service servers (e.g., 170a). The service servers (e.g., 170a) include a presence server 170a, a calendar server 170b, an messaging server 170c, a conference server 170d, a collaboration server 170e, and a location server 170f.

In some examples, the computing device 120 is a cell phone, a computer, a television with set top box, other types of display devices with input devices, and/or other types of audio devices with audio input devices. Although the exemplary network 130 is a wireless network, the network 130 can be, for example, a wired network, a cable television network, a computer network, a packet based network (e.g., using IP), an asynchronous transfer mode (ATM) network, and/or a circuit based network, including a landline telephone network, a cellular network, a personal communications service (PCS) network, a global system for mobile communication (GSM) network, an enhanced general packet radio service (EDGE) network, and/or other public switched telephone network (PSTN) type networks.

In other examples, the service broker server 150 resolves conflicts between blended services packages (e.g., 180a), prioritizes service packages (e.g., if the user 110 has subscribed to more than one service package), and/or performs resource management for the service servers. The service broker database 152 includes information associated with resource management (e.g., usage of service servers), user information (e.g., user subscriptions, user subscriptions to one or more service packages), and/or service network information (e.g., communication paths to service servers).

In some examples, the service servers (e.g., 170a) include other types of servers associated with services for users (e.g., 110a), and/or other types of servers associated with services for networks (e.g., 130). The service servers (e.g., 170a) can be, for example, a presence server, a calendar server, a messaging server, a conference server, a collaboration server, a location server, a personalization server, an electronic mail server, a business communication server, a phone server, a voicemail server, an internet television server, and/or a storage server.

In other examples, the service servers (e.g., 170a) include servers associated with IPTV capabilities, message conversion, presence status capabilities, calendar capabilities, message transmission and receiving capabilities, conference capabilities, location identification capabilities, social attribute identification capabilities, business communication capabilities, electronic mail capabilities, phone capabilities, voicemail capabilities, television capabilities, and/or storage capabilities. The IPTV capabilities include, for example, advertisement insertion, extracting user preferences from a content search application, and/or content searching. Another advantage is that the integration of the telecommunication capabilities provides for a synergistic combination of services to a user. Another advantage is that the integration of the telecommunications capabilities allows for capabilities to expand its services by combining information from other capabilities.

In other examples, the service servers include a personal service server 160. The personal service server 160 monitors user requests for services and stores the user requests in the personal service database 162. The personal service server 160 processes the stored user requests to determine usage patterns. The personal service server 160 processes the usage patterns to determine future requests (e.g., The personal service asks: Do you want to have dinner with your golf buddies on Friday night at the country club?) and/or to determine how to fulfill a request (e.g., You tell the personal service: Schedule dinner with my golf buddies on Friday night at our favorite restaurant.). The personal service server 160 processes the request by communicating with the service broker server 150, a blended service package (e.g., 180a), and/or one or more service servers (e.g., 170a). The personal service is described in U.S. patent application Attorney Docket No. SNS-023, entitled “Personal Service Integration on a Network,” U.S. Patent Application No. TBD, filed on May 3, 2007, which is incorporated by reference.

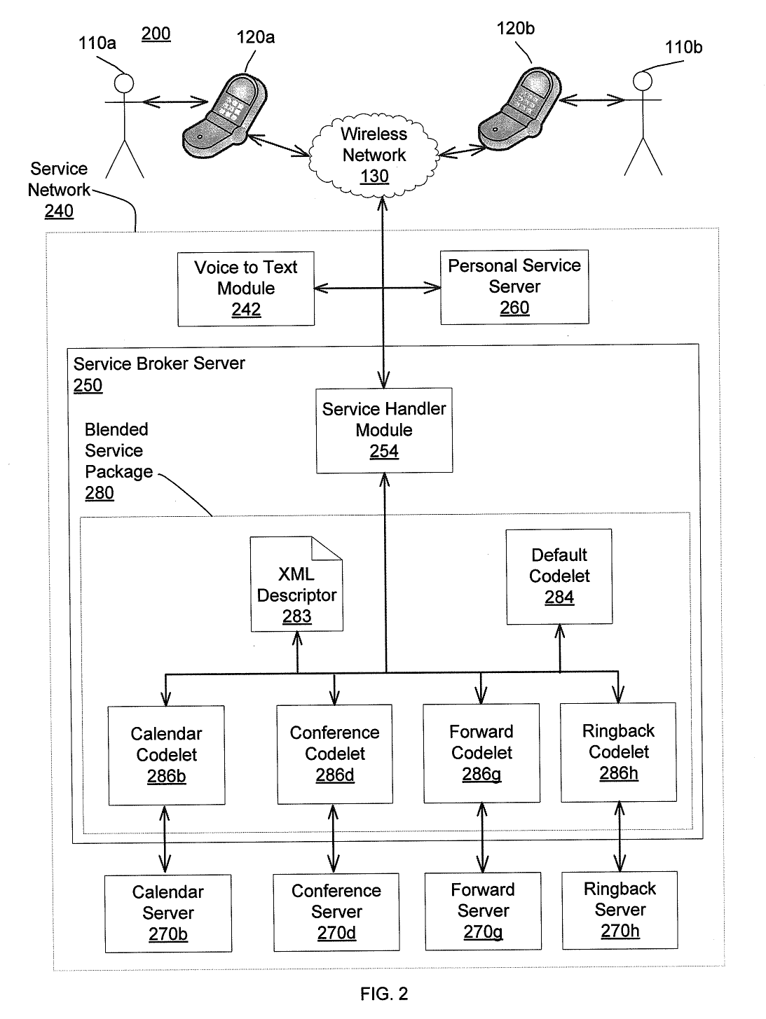

FIG. 2 is a functional block diagram of an exemplary system 200 illustrating a blended service package 280 providing service integration on a network 130. A user 110a or 110b (generally 110) utilizing a computing device 120a or 120b (generally 120) accesses a service network 240 through a wireless network 130. The service network 240 includes a voice to text module 242, a personal service server 260, a service broker server 250, a calendar server 270b, a conference server 270d, and a location server 270f. The service broker server 250 includes a service handler module 254 and a blended service package 280. The blended service package 280 includes an XML descriptor file 283, a default codelet 284, a calendar codelet 286b, a conference codelet 286d, and a location codelet 286f.

The user 110 utilizing the computing device 120 makes a service request through the wireless network 130. The service handler module 254 receives the service request and calls a default codelet 284 associated with a blended service package 280 that is associated with the user 110.

In some examples, the service handler module 254 dynamically calls a plurality of service codelets (e.g., 286b) that are needed to fulfill the user's request. Each called service codelet (e.g., 286b) communicates with a service server (e.g., 270b) to receive, update, and/or add information associated with the user request. The service codelet (e.g., 286b) returns information associated with the request to the service codelet (e.g., 286b) which communicates the information to the service handler module 254.

In other examples, the default codelet 284 dynamically calls a plurality of service codelets (e.g., 286b) that are needed to fulfill the user's request. Each called service codelet (e.g., 286b) communicates with a service server (e.g., 270b) to receive, update, and/or add information associated with the user request. The service codelet (e.g., 286b) returns information associated with the request to the service codelet (e.g., 286b) which communicates the information to the default codelet 284.

For example, a first user 110a sets her preferences up to forward all phone calls to her office phone to her cell phone 120a and to have a personalized ringback for phone calls from certain numbers (e.g., her mother). A second user 110b (e.g., the first user's mother) utilizing her cell phone 120b makes a request through the network 130. The service broker server 250 receives the request from the second user 110b to establish a phone call to the first user's office phone. The service broker server 250 calls a default codelet 284 associated with the blended service package 280 associated with the first user 110a. Based on the first user preferences, the default codelet 284 calls the forward codelet 286f. The forward codelet 286f communicates with a phone call forwarding server 270f to forward the phone call from the first user's office phone to the first user's cell phone 120a. The forward codelet 286f calls the ringback codelet 286h based on the first user's preferences. The ringback codelet 286h communicates with a ringback phone server 270h to check to determine if the phone call is from a number listed in the first user's preferences. If the phone call is from a number listed in the first user's preferences, then the ringback codelet 286h requests that the ringback phone server 270h supply the specified ringback for use in the telephone call. The phone call is connected to the first user's cell phone 120a with the specified ringback.

In other examples, the service handler module 254 maintains availability information, resource utilization, and/or load information for each of the service servers (e.g., 270b). In some examples, the service handler module 254 provides exception handling software as described below. The service handler module 254 can determine, for example, an alternative service server if the selected service server is unavailable. For example, if the calendar service 270b is unavailable, then the service handler module 254 instructs the blended service package 280 to contact the presence server for an individual's location information. For example, if a first calendar server 270b is unavailable, then the service handler module 254 instructs the blended service package 280 to contact a second calendar server (not shown) for the calendar information.

In other examples, the service handler module 254 load balances user requests for services across a plurality of service servers associated with the information for the user request. The load balancing by the service handler module 254 can utilize, for example, the number of active sessions to the service servers, the status of the service servers (e.g., heartbeat mechanism), and/or the timestamp of last access for the service servers.

In some examples, the blended service package 280 is determined based on the user's preferences, a service package associated with the user, and/or other configuration information associated with the user. A user can be, for example, associated with one or more blended service packages (e.g., 280). For example, a user can be associated with a corporate blended service package which provides business type services (e.g., messaging, phone forwarding, calendar) and a personal blended service package which provides personal type services (e.g., ringback, social attributes). If the user made a request for a meeting with her boss at 3:00 pm on a Monday, then based on configuration data associated with the service package (e.g., business hours are Monday through Friday 8:00 am to 5:00 pm) the corporate blended service package would be utilized for the user request. If the user made a request for dinner reservations for four at 8:00 pm on a Saturday, then based on the user's preferences (e.g., all reservations on the weekend are personal) the personal blended service package would be utilized.

The service handler module 254 dynamically calls, for example, the service codelets (e.g., 286b) associated with the blended service package 280. The service codelets (e.g., 286b) called by the service handler module 254 can be, for example, associated with a user 110, a set of users, all users, a user's service package, and/or as a service network framework. Although FIG. 2 illustrates each service codelet (e.g., 286b) communicating with one service server (e.g., 286b), each service codelet (e.g., 286b) can communicate, for example, with a plurality of service servers (e.g., 270b and 270d).

The service handler module 254 can generate, for example, a list of service codelets (e.g., calendar codelet, conference codelet, presence codelet). The list of service codelets can be, for example, generated dynamically based on user information, service network information, information associated with the user request, and/or other information associated with the services. The list of service codelets can be utilized, for example, to ensure that the called service codelets return information (e.g., contact information), access information in a designated order (e.g., first retrieve the boss's schedule and then retrieve the subordinate schedules), complete assigned tasks (e.g., update calendar entry), and/or complete assigned tasks in a designated order (e.g., first check calendar and then make dinner reservations).

For example, a first user 110a wants to set up a conference with a second user 110b and a third user (not shown) as soon as possible. The first user 110a utilizing his cell phone 120a dials the second user 110b and the third user's office numbers. The service broker server 250 receives the call. The service broker server 250 communicates with the service handler module 254 to initiate the conference call. The service handler module 254 calls a blended service package (e.g., 280) selected from a plurality of blended service packages. The service handler module 254 calls the default codelet 284 associated with the blended service package 280. The service handler module 254 generates a list of service codelets based on information associated with the first user 110a (e.g., service package subscription). Table 1 illustrates an example of the list of service codelets which includes the conference codelet 286d. Based on the list of service codelets, the service handler module 254 calls the conference codelet 286d which communicates with the conference server 270d to determine what information is needed to setup the requested conference call. Based on the information from the conference server 270d, the conference codelet 286d adds the presence codelet to the list of service codelets as illustrated in table 2.

TABLE 1
List of Service Codelets
List of Service Codelets

Conference Codelet

TABLE 2
List of Service Codelets
List of Service Codelets

Presence Codelet
Conference Codelet

The service handler module 254 calls the presence codelet. The presence codelet communicates with the presence server (not shown) to determine the second user 110b and third user's location. The presence server responds to the service handler module 254 that the second user 110b is available via his cell phone 120a and that the third user is out of cell phone range. The presence codelet adds the message codelet (not shown) to the list of service codelets. Upon returning the second user 110b and third user information to the service handler module 254, the presence codelet is removed from the list of service codelets as illustrated by table 3.

TABLE 3
List of Service Codelets
List of Service Codelets

Message Codelet
Conference Codelet

The service handler module 254 calls the message codelet. The message codelet communicates with the message server (not shown) to send a message to the third user that that the first user 110a wants to have a conference call as soon as possible. The third user communicates to the message server to call a phone number at the third user's location for the conference call. The message server communicates the phone number for the third user to the service handler module 254. Upon returning the third user information to the service handler module 254, the message codelet is removed from the list of service codelets as illustrated in table 4.

TABLE 4
List of Service Codelets
List of Service Codelets

Conference Codelet

The service handler module 254 calls the conference codelet 286d and sends the second user 110b and third user information. The conference codelet 286d calls the conference server 270d which dials the second user's cell phone 120b number and the telephone number provided by the third user to complete the first user's conference call request. Upon completion of the setup of the conference call in response to the first user's request, the conference codelet 286d is removed from the list of service codelets. Since the list of service codelets is empty (as illustrated in table 5) and the user request is complete, the service handler module 254 returns to the service broker server 250.

TABLE 5
List of Service Codelets
List of Service Codelets

In some examples, the list of service codelets is the execution sequence for the calling of the service codelets (e.g., 286d). The execution sequence can be modified, for example, by the service codelets based on the information requested and/or received from the service servers. The modification of the execution sequence can include, for example, the deletion, addition, and/or reordering of entries (e.g., message codelet inserted before conference codelet). The execution sequence can be modified, for example, based on the load of the service server (e.g., 90% CPU utilization), the capability of the service server (e.g., instant messaging but no email), time, user's location information, user's presence information, user's registration, network policies, and/or user preferences (e.g., no calls between 6 pm-8 pm). An advantage is that the service codelets can dynamically modify the sequence of service codelet execution based on information associated with the service servers.

The service handler module 254 can define, for example, a predetermined grouping of service codelets (e.g., 286h). The predetermined grouping of service codelets can be, for example, utilized for predetermined user requests (e.g., phone forwarding utilizes the presence codelet and the forward codelet 286g). The service codelets (e.g., 286b) can be, for example, associated with the blended service package 280 based on the user's preferences, a blended service package 280 associated with the user 110, and/or other configuration information associated with the user 110.

In other examples, the XML descriptor file 283 includes information defining when to call the default codelet 284. The XML descriptor file 283 can include, for example, information defining when to call one or more of the service codelets (e.g., 286b) at runtime. For example, the XML descriptor file 283 includes information that when a user 110 makes a request for dinner reservations with a second person that the service handler module 254 calls the calendar codelet 286b first to determine if the second person is available for dinner, then calls the presence codelet (not shown) to determine how to contact the second person, and then calls the messaging codelet (not shown) to communicate with the second person about whether they would like to join the user 110 for dinner.

In some examples, the service handler module 254 dynamically calls the service codelets (e.g., 286b) to request information from the associated services (e.g., calendar data) and/or perform tasks with the associated services (e.g., update calendar). In other examples, the service codelets (e.g., 286b) can dynamically call other service codelets (e.g., 286d) based on the results of their requests for information. For example, the conference codelet 286d receives calendar information from the calendar codelet 286b that a party for a conference call is out of town. Based on the calendar information that the party is out of town, the conference codelet 286d calls the presence codelet (not shown) to determine where the party is located and how to contact the party. The presence codelet communicates presence information back to the conference codelet 286d regarding how to contact the party for the conference call.

In other examples, new services can be added to the service network 240 by creating new service codelets (e.g., 286b) that interact with the new service. New service codelets (e.g., 286b) can be, for example, created for existing services (e.g., calendar service) to allow for different types of access to the information associated with the service. For example, a first calendar codelet can be utilized to check on calendar availability and a second calendar codelet can be utilized to schedule meetings. The first calendar codelet and the second calendar codelet both can access, for example, the same calendar server. An additional advantage to the integration of services on a network is that an existing service can be added into an integration of services without modifying the existing services by utilizing the ability to request information from the existing services and/or perform tasks with the existing services. Another advantage is that the ability to add, delete, and/or modify the services that are available for integration on a network allows for services to be quickly and efficiently integrated into other services on a network.

In some examples, the information from the services (e.g., conference, calendar, presence) is integrated together and returned to the user 110. A service codelet (e.g., 286b) can call, for example, one or more other service codelets (e.g., 286d) to complete a task for a user. For example, the conference codelet 286d calls the calendar codelet 286b to determine if the individuals for a conference call are available. Another advantage is that service codelets can be chained together so that multiple services can act on the same user request.

In other examples, the service codelets (e.g., 286b) are reentrant software. The service codelets (e.g., 286b) can be, for example, multi-threaded software. The service codelets (e.g., 286b) can be, for example, a Java class file, a Java bytecode file, executable files loaded at runtime, and/or platform independent executable files. An advantage is that the service codelet can be defined and deployed at runtime.

In some examples, the voice to text module 242 receives audio requests from the user 110 and converts the audio requests to non-audio requests (e.g., text). An advantage is that different types of requests can be utilized by the service network to provide integrated services to users.

In some examples, the service handler module 254 includes exception handling software. The exception handling software can receive, for example, timeout information from called service codelets (e.g., 286g) that are associated with the service servers (e.g., 270b). In other examples, the timeout information is information from a service server (e.g., 270b) that it is unable to process the request and/or other types of information that indicates that a request cannot be processed within a predetermined or dynamically generated time period.

For example, the exception handling software monitors a request from the service handler module 254 to the calendar codelet 286b for information from the calendar server 270b. If a response is not received within a predetermined amount of time (e.g., one second, ten seconds), then the exception handling software stops the default codelet 284 from calling the next service codelet (e.g., 286h) that is scheduled and calls an exception handling codelet (not shown). The exception handling codelet contacts a second calendar server (not shown) to determine if it is available. If the second calendar server is available, then the exception handling codelet communicates with the second calendar server to process the request. After the response is received, then the exception handling codelet returns control of the processing to the service handler module 254.

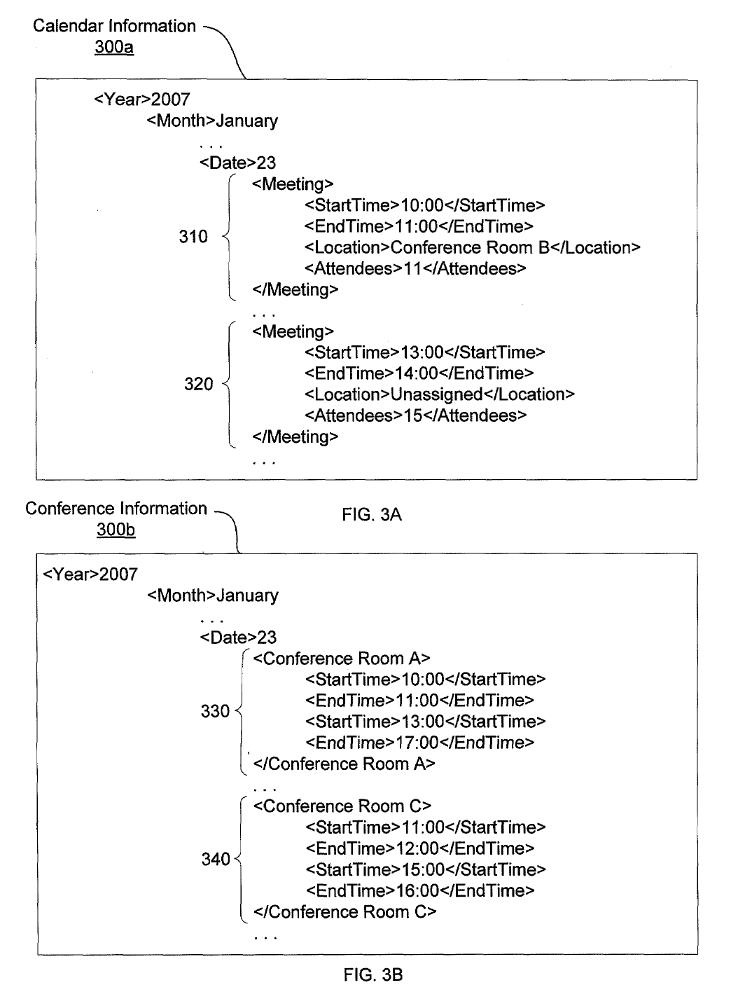

FIG. 3A is a diagram of exemplary calendar data 300a. The calendar information 300a includes calendar information for meetings 310 and 320. The calendar information for meetings 310 and 320 includes start time, end time, location, and number of attendees for the meeting.

FIG. 3B is a diagram of exemplary conference information 300b. The conference information 300b includes conference room information for conference room A 330 and conference room C 340. The conference room information 330 and 340 includes start times and end times for meetings scheduled in the conference room.

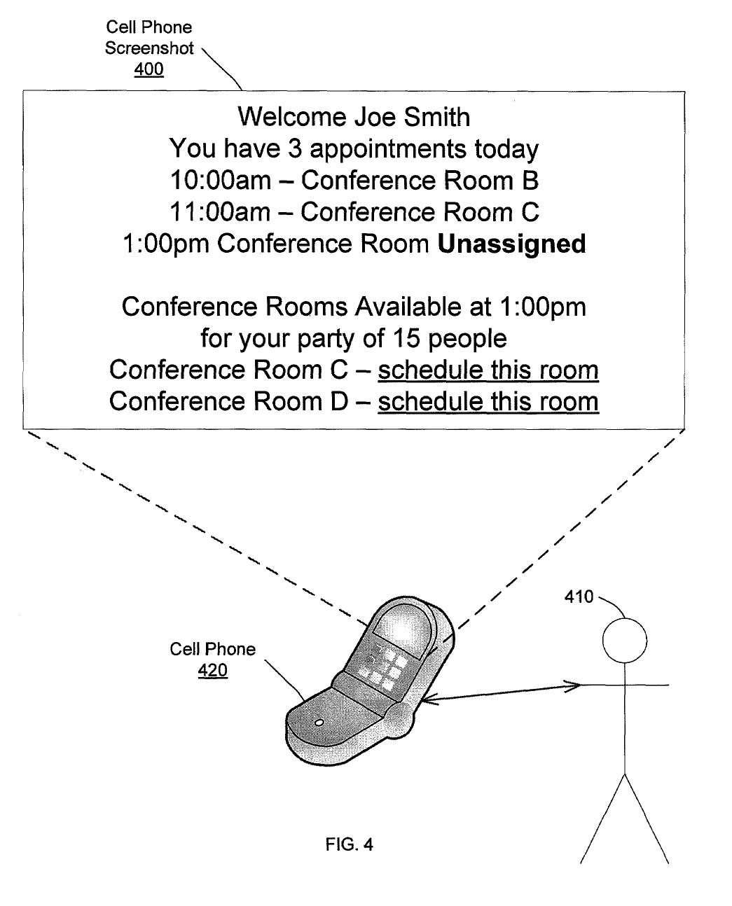

FIG. 4 is a exemplary screenshot 400 of information illustrating an interaction between a user 410 and a service broker server 250 through the exemplary system 200 of FIG. 2 using the calendar information 300a of FIG. 3A and the conference information 300b of FIG. 3B. A user 410 sets his preferences up for his cell phone 420 to display his schedule for the day (e.g., 10:00 am—Conference Room B) and if any of his appointments are missing locations (e.g., 1:00 pm Conference Room Unassigned), to find available locations for the meeting (e.g., Conference Room C—schedule this room). The user 410 utilizes his cell phone 420 to view his appointments for the day as illustrated by the cell phone screenshot 400. The cell phone 420 requests the user's appointment information from the service broker server 250. The service broker server 250 calls a default codelet 284 associated with a blended service package 280 associated with the user 410. The default codelet 284 calls a calendar codelet 286b based on the user's preferences for viewing his calendar. The calendar codelet 286b requests the user's calendar information from a calendar server 270b. The calendar information 300a includes meeting information 310 and 320.

The calendar server 270b returns the user's calendar information to the default codelet 284 through the calendar codelet 286b. The default codelet 284 processes the user's calendar information and determines that one of the user's appointments is missing a location (e.g., <Location>Unassigned</Location>). Based on the user's preference for finding locations for his appointments, the default codelet 284 calls a conference codelet 286d. The conference codelet 286d requests conference information 300b from a conference server 270d regarding rooms that are available for the user's meeting. The conference server 270d returns the conference information 300b to the conference codelet 270d which returns the information to default codelet 284. The default codelet 284 processes the conference information 300b and sends the calendar information 300a along with the available locations for the appointment missing a location (e.g., Conference Room C—schedule this room) back to the user's cell phone 420.

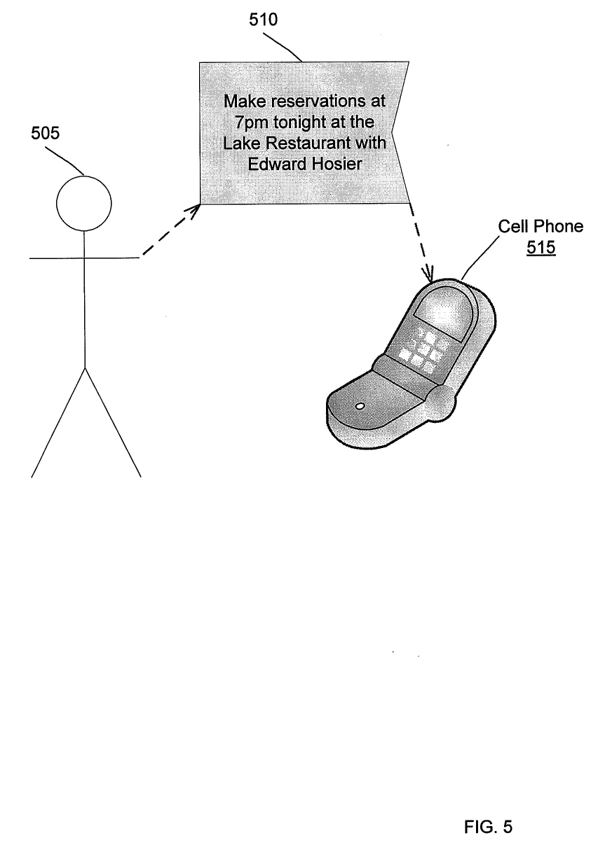

FIG. 5 is an exemplary diagram 500 illustrating an interaction between a user 505 and a cell phone 515 to place a request 510. The user 505 makes the request 510 through the cell phone 515 for reservations at 7 pm at the Lake Restaurant with Edward Hosier.

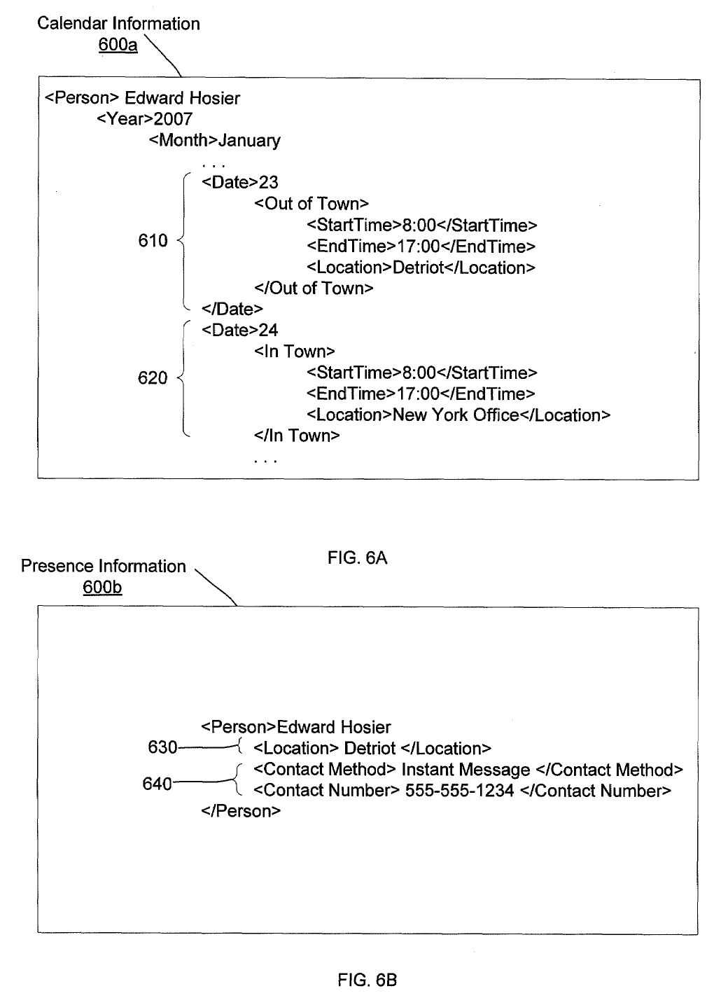

FIG. 6A is a diagram of exemplary calendar information 600a. The calendar information 600a includes out of town information 610 and in town information 620 associated with a person (e.g., Edward Hosier).

FIG. 6B is a diagram of exemplary presence information 600b. The presence information 600b includes the location 630 of a person (e.g., Edward Hosier) and how to contact 640 the person.

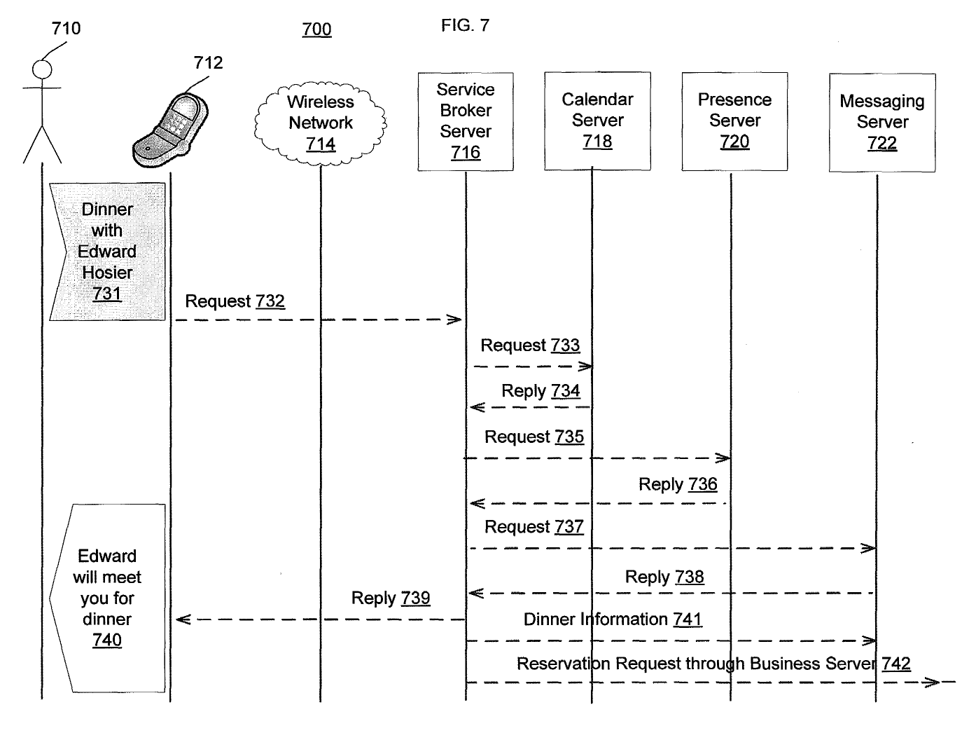

FIG. 7 is an exemplary process diagram 700 illustrating an interaction between a user 710 and a service network to place a request utilizing the calendar information 600a in FIG. 6A and presence information 600b in FIG. 6B. The user 710 makes a request 731 through a computing device 712 for reservations at 7 pm tonight at the Lake Restaurant with Edward Hosier (as illustrated by the request 510 in FIG. 5). The computing device 712 communicates the request 732 to a service broker server 716 through a wireless network 714. The server broker server 716 processes the request 732 and communicates with the calendar server 718 via a request 733 and a reply 734 to receive calendar information 600a for Edward Hosier. The calendar information 600a for the day, Jan. 23, 2007, of the exemplary request 731 indicates that Mr. Hosier is out of town. However, the end time for the out of town information 610 indicates that the out of town calendar entry ends at 5:00 pm.

The server broker server 716 communicates with a presence server 720 via a request 735 and a reply 736 to access location information 630 and contact information 640 for Mr. Hosier. The server broker server 716 communicates with a messaging server 722 via a request 737 and a reply 738 utilizing the contact information 640 accessed from the presence server 720. The messaging server 722 communicates with Mr. Hosier via instant messaging to determine if Mr. Hosier would like to attend dinner with the user 710. Mr. Hosier responds to the messaging server 722 that he would like to attend dinner with the user 710. The server broker server 716 communicates a reply 739 to the user 710 through the computing device 712 indicating that “Edward will meet you for dinner” 740. The service broker server 716 communicates the dinner information 741 to Mr. Hosier through the messaging server 722. The service broker server 716 makes a reservation request 742 through a business server (not shown).

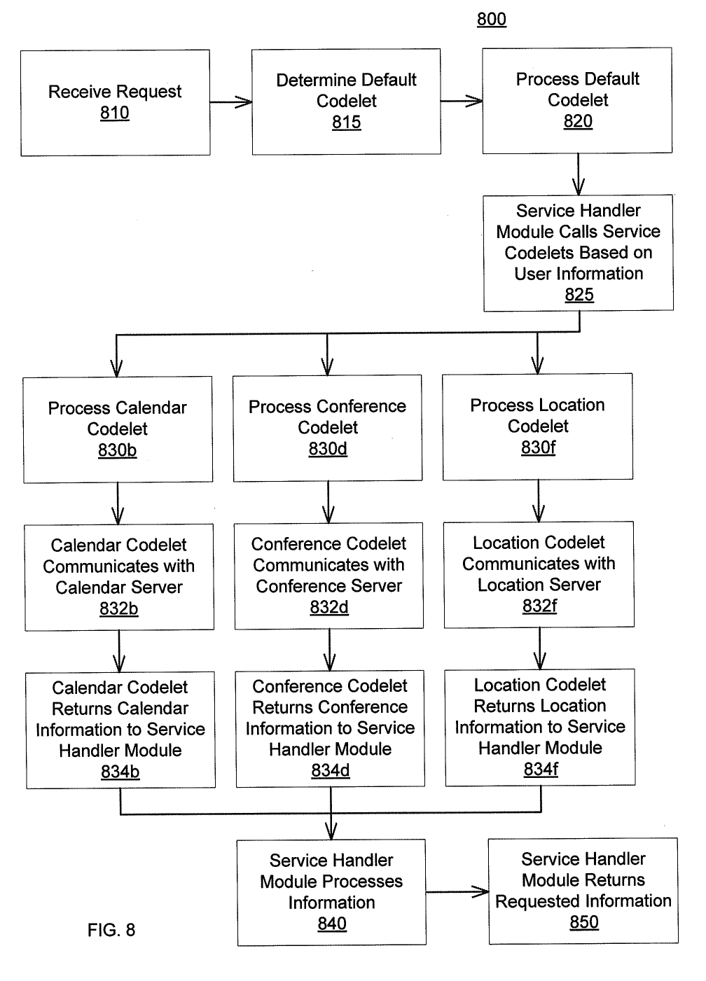

FIG. 8 is an exemplary flowchart 800 depicting processing of a default codelet 284 and service codelets (e.g., 286d) through the exemplary system 200 of FIG. 2. A service handler module 254 in a service broker server 250 receives (810) a request. The service handler module 254 determines (815) a default codelet 284 associated with a blended service package 280. The blended service package 280 can be, for example, associated with a user 110.

The default codelet 284 is processed (820) to determine which service codelets (e.g., 286b) to call to process the request. The service handler module 254 calls (825) a calendar codelet 286b, a conference codelet 286d, and a location codelet (not shown) based on information associated with the user. The calendar codelet 286b is processed (830b) to determine what information needs to be accessed. The calendar codelet 286b communicates (832b) with a calendar server 270b to access calendar information (e.g., a user's calendar for a certain day). The calendar codelet 286b returns (834b) the calendar information to the service handler module 254.

The conference codelet 286d is processed (830d) to determine what information needs to be accessed. The conference codelet 286d communicates (832d) with a conference server 270d to access the conference information (e.g., what conference rooms are available). The conference codelet 286d returns (834d) the conference information to the service handler module 254.

The location codelet (not shown) is processed (830f) to determine what information needs to be accessed. The location codelet communicates (832f) with a location server (not shown) to access location information (e.g., where an individual is). The location codelet returns (834f) the location information to the service handler module 254.

The service handler module 254 processes (840) the calendar information, the conference information, and the location information to integrate the information together for the user 110. The service handler module 254 returns (850) the integrated information to the user 110.

Although FIG. 8 illustrates the service codelets (e.g., 286b) operating in a parallel form, the service codelets (e.g., 286b) can be, for example, prioritized so that the processing and the communication occur in a selected order. The prioritization can be based, for example, on static information associated with the service network 240, dynamically generated information associated with the service network 240 (e.g., a set of service servers is unavailable), utilization of a service server, capability of a service server, time of request, user's location information, user's presence information, user's registration information, policies of the service network, and/or user's preferences. For example, the location codelet (not shown) is prioritized to be processed 830f first and then the calendar codelet 286b and the conference codelet 286d are processed 830b and 830d, respectively. Another advantage is that the sequence of the service codelets can be prioritized so that multiple services can effectively act on the same user request.

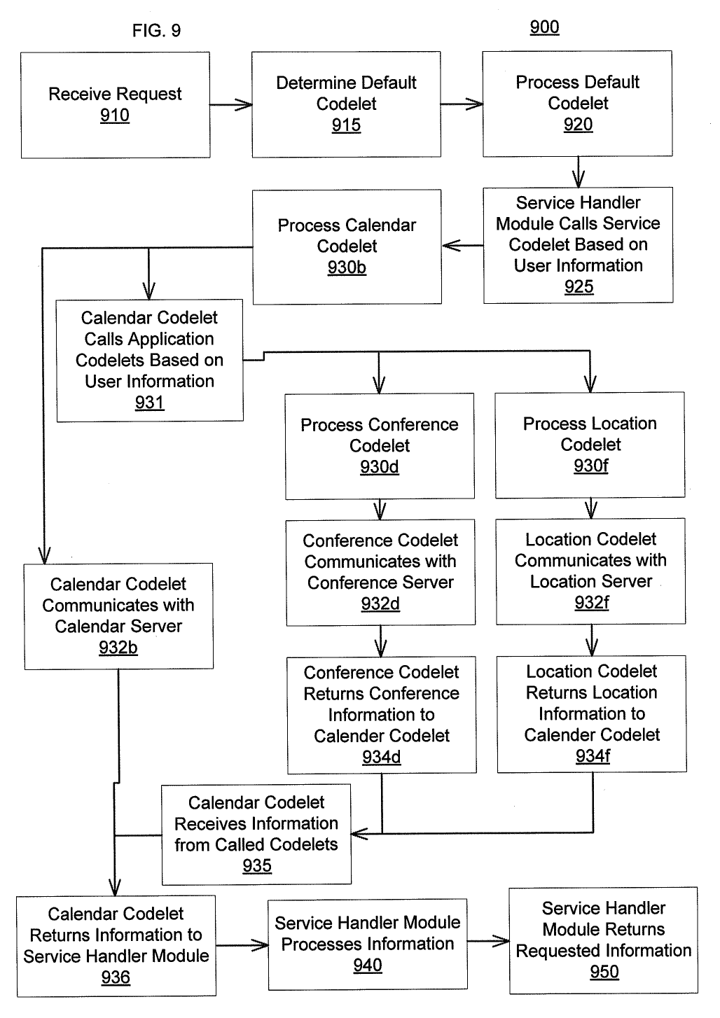

FIG. 9 is an exemplary flowchart 900 depicting processing of a default codelet 284 and service codelets (e.g., 286b) through the exemplary system 200 of FIG. 2. A service handler module 254 in a service broker server 250 receives (910) a request. The service handler module 254 determines (915) a default codelet 284 associated with a blended service package 280. The blended service package 280 can be, for example, associated with a user 110.

The default codelet 284 is processed (920) to determine which service codelets (e.g., 286b) to call to process the request. The service handler module 254 calls (925) a calendar codelet 286b based on information associated with the user. The calendar codelet 286b is processed (830b) to determine what information needs to be accessed. The calendar codelet 286b calls a conference codelet 286d and a location codelet (not shown) based on the user information and the request. The calendar codelet 286b communicates (932b) with a calendar server 270b to access calendar information (e.g., a user's calendar for a certain day).

The conference codelet 286d is processed (930d) to determine what information needs to be accessed. The conference codelet 286d communicates (932d) with a conference server 270d to access the conference information (e.g., what conference rooms are available). The conference codelet 286d returns (934d) the conference information to the calendar codelet 286b. The location codelet (not shown) is processed (930f) to determine what information needs to be accessed. The location codelet communicates (932f) with a location server (not shown) to access location information (e.g., where an individual is). The location codelet returns (934f) the location information to the calendar codelet 286b.

The calendar codelet 286b returns (936) the calendar information, the conference information, and the location information to the service handler module 254. The service handler module 254 processes (940) the calendar information, the conference information, and the location information to integrate the information together for the user 110. The service handler module 254 returns (950) the integrated information to the user 110.

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device and/or in a propagated signal, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The system can include clients and servers. A client and a server are generally remote from each other and typically interact through a communication network. The relationship of client and server arises by virtue of computer programs running on the respective computers and having a client-server relationship to each other.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device.

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

The components of the system can be interconnected by any form or medium of digital data communication (e.g., a communication network). Examples of communication networks include a local area network (LAN), a wide area network (WAN), the Internet, wired networks, wireless networks, a packet-based network, and/or a circuit-based network.

Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The computing device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a Blackberry®.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method for service integration on a network, the method comprising:
receiving a request from a user;
associating a default codelet with the request;
processing the default codelet to associate a plurality of service codelets with the request;
processing a first codelet from the plurality of service codelets to communicate with a first resource server; and
processing a second codelet from the plurality of service codelets to communicate with a second resource server;
wherein the first codelet is different from the second codelet, and
wherein the first resource server is different from the second resource server.

2. The method of claim 1 wherein the second codelet utilizes results from the processing of the first codelet.

3. The method of claim 1 wherein processing the default codelet further comprises selecting a third codelet based on a default template, information associated with the user, policy information associated with a business application, or any combination thereof.

4. The method of claim 1 further comprising:
processing a third codelet from the plurality of service codelets to communicate with a third resource server;
wherein the third codelet is selected based on processing the first codelet.

5. The method of claim 4 further comprising:
processing a fourth codelet from the plurality of service codelets to communicate with a fourth resource server;
wherein the fourth codelet is selected based on processing the first codelet.

6. The method of claim 5 wherein a blended service package comprises the default codelet, the first codelet, the second codelet, the third codelet, the fourth codelet, a extensible markup language descriptor file, or any combination thereof.

7. The method of claim 5 wherein the fourth codelet is prioritized for processing before the third codelet.

8. The method of claim 1 wherein processing the default codelet further comprises generating a list of codelets.

9. The method of claim 1 further comprising defining a predetermined grouping comprising the first codelet and the second codelet.

10. The method of claim 1 further comprising deploying the first codelet and the second codelet at runtime.

11. The method of claim 1 further comprising associating the first resource server with one or more application servers.

12. The method of claim 11 wherein the one or more application servers comprise a presence server, a calendar server, a messaging server, a conference server, a collaboration server, a location server, a personalization server, an electronic mail server, a business communication server, a phone server, a voicemail server, an internet television server, a storage server, or any combination thereof.

13. The method of claim 1 wherein the first resource server is associated with message conversion, presence status capabilities, calendar capabilities, message transmission and receiving capabilities, conference capabilities, location identification capabilities, social attribute identification capabilities, business communication capabilities, electronic mail capabilities, phone capabilities, voicemail capabilities, television capabilities, storage capabilities, or any combination thereof.

14. The method of claim 1 wherein the first resource server is associated with one or more IPTV capabilities.

15. The method of claim 14 wherein the one or more IPTV capabilities comprises advertisement insertion, extracting user preferences from a content search application, content searching, or any combination thereof.

16. The method of claim 1 wherein the first resource server is associated with a personal service server.

17. The method of claim 1 wherein the plurality of service codelets comprises reentrant software.

18. The method of claim 1 wherein the plurality of service codelets comprises multi-threaded software.

19. A computer program product, tangibly embodied in an information carrier, the computer program product including instructions being operable to cause a data processing apparatus to:
receive a request from a user;
associate a default codelet with the request;
process the default codelet to associate a plurality of service codelets with the request;
process a first codelet from the plurality of service codelets to communicate with a first resource server; and
process a second codelet from the plurality of service codelets to communicate with a second resource server;
wherein the first codelet is different from the second codelet, and
wherein the first resource server is different from the second resource server.

20. A system for service integration on a network, the system comprising:
a service handler module configured to receive a request from a computing device;
a default codelet configured to associate a plurality of service codelets with the request;
a first codelet from the plurality of service codelets configured to communicate with a first resource server; and
a second codelet from the plurality of service codelets configured to communicate with a second resource server;
wherein the first codelet is different from the second codelet,
wherein the first resource server is different from the second resource server.

21. The system of claim 20 further comprising:
a third codelet from the plurality of service codelets configured to communicate with a third resource server;
wherein the third codelet is selected by the first codelet.

22. The system of claim 21 further comprising:
a fourth codelet from the plurality of service codelets configured to communicate with a fourth resource server;
wherein the fourth codelet is selected by the first codelet.

23. The system of claim 20 further comprising a voice to text module configured to convert the request from an audio format to a non-audio format.

24. A system for service integration on a network, the system comprising:
a means for receiving a request from a computing device;
a means for associating a plurality of service codelets with the request;
a means for communicating with a first resource server; and
a means for communicating with a second resource server;
wherein the means for communicating with the first resource server is different from the means for communicating with the second resource server,
wherein the first resource server is different from the second resource server.
